(19) United States
(12) Patent Application Publication
(10) Pub. No.: US 2005/0118022 A1
(43) Pub. Date: Jun. 2, 2005

(54) Portable and movable fan device

(76) Inventor: Chiao Fu, Taichung (TW)

Correspondence Address: Chiao Fu, P.O. Box 63-99, Taichung, 406, TW

(21) Appl. No.: 10/727,754

(22) Filed: Dec. 2, 2003

(51) Int. Cl. F03D 1/00

(52) U.S. Cl. 416/63

(57) ABSTRACT

A fan device includes a net housing having a front cover and a rear casing secured together, and having a concaved chamber formed the casing to receive and protect a motor. A fan member is attached to the spindle of the motor and to be driven by the motor. The motor is received within the concaved chamber of the casing of the housing, and protected by the casing of the housing, and may thus be prevented from being damaged by other or outer objects inadvertently. A carrier includes two arms to stably secure the net housing, and one or more wheels to easily move the carrier.

### BACKGROUND OF THE INVENTION

1. Field of the Invention

The present invention relates to a fan device, and more particularly to a portable and movable fan device having a stable support.

2. Description of the Prior Art

Various kinds of typical fan devices have been developed and comprise a fan housing stably or rotatably supported on a stationary base. For example, U.S. Pat. No. 1,597,871 to Reynders discloses one of the typical fan devices including a bolt to secure the fan housing to the stationary base. However, the motor is exposed and may have a good chance to be damaged by outer or other objects.

U.S. Pat. No. 2,652,974 to Fettel discloses another typical fan device including a clock spring to resiliently support or position the fan housing to the stationary base. However, the motor is also exposed and may have a good chance to be damaged by outer or other objects.

U.S. Pat. No. 4,732,539 to Shin-Chin discloses a further typical fan device including a tilt limiting or regulating clip to position the fan housing to the stationary base. However, the motor is also exposed and may have a good chance to be damaged by outer or other objects.

U.S. Pat. No. Re. 34,551 to Coup et al., and U.S. Pat. No. 6,293,755 to Fu disclose two still further typical fan devices including a fan housing attached to or rotatably supported on a stationary base. However, the motor is also exposed and may have a good chance to be damaged by outer or other objects.

In addition, in the typical fan devices, the stationary base should include a heavy weight to stably support the fan devices in place when the fan devices are actuated or operated. However, the typical fan devices may not be easily moved or transported due to the heavy stationary bases.

U.S. Pat. No. 5,368,453 to Peng discloses a still further typical fan device including a base portion having four rollers attached to the bottom, for allowing the fan housing to be easily moved or transported by users. However, the base portion may be easily slip or moved everywhere by the rollers when the fan devices are actuated or operated.

The present invention has arisen to mitigate and/or obviate the afore-described disadvantages of the conventional fan devices.

### SUMMARY OF THE INVENTION

The primary objective of the present invention is to provide a portable and movable fan device including a stable support to allow the fan device to be stably positioned in place, and to be easily moved or transported to the other places or positions.

In accordance with one aspect of the invention, there is provided a fan device comprising a net housing including a front cover and a rear casing secured together, the casing including a concaved chamber formed therein, a motor received in the concaved chamber of the casing, and including a spindle extended into the net housing, and a fan member attached to the spindle, and to be driven by the motor. The motor is received within the concaved chamber of the casing of the housing, and protected by the casing of the housing, and may thus be prevented from being damaged by other or outer objects inadvertently.

The casing of the housing includes a hub provided therein, the motor includes at least one ear extended therefrom and secured to the hub of the housing. A switch device may further be provided and received in the concaved chamber of the casing, and secured to the casing.

The cover and the casing include inner peripheral portions contacted with each other, and the housing includes a peripheral frame engaged onto the inner peripheral portions of the cover and the casing, to secure the cover and the casing together.

The peripheral frame includes a peripheral recess formed therein and defined between two flaps, to receive and secure the inner peripheral portions of the cover and the casing together.

A carrier may further be provided to support the net housing. The carrier includes a front portion and a rear portion each having an arm extended therefrom, to secure the net housing between the arms of the carrier.

Each of the arms includes a pad attached thereto and engaged with the net housing, to protect the housing. Each of the arms includes a bar attached thereto to support the pad.

The carrier includes at least one wheel attached thereto to allow the carrier to be easily moved. The carrier includes at least one leveling screw attached thereto to level the carrier. The carrier includes a bracket attached thereto to support the leveling screw.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a portable and movable fan device in accordance with the present invention;

FIG. 2 is an exploded view of the portable and movable fan device;

FIG. 3 is a partial cross sectional view of the portable and movable fan device; and

FIGS. 4, 5 are enlarged partial cross sectional views of the portable and movable fan device.

### DETAILED DESCRIPTION OF THE PREFERRED EMBODIMENT

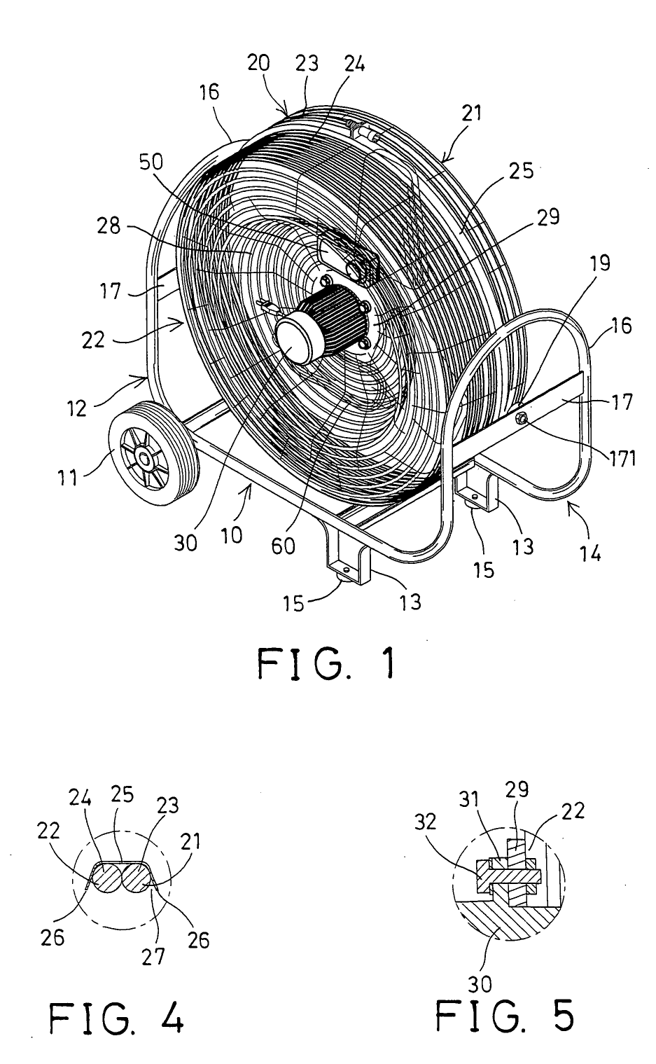

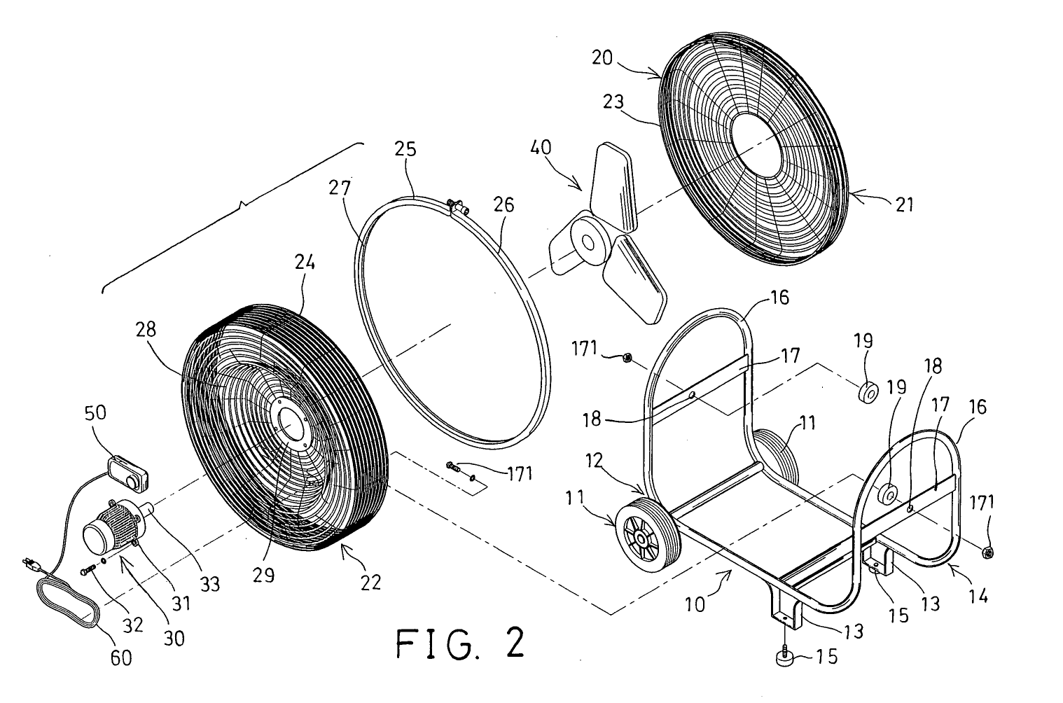

Referring to the drawings, and initially to FIGS. 1-3, a portable and movable fan device in accordance with the present invention comprises a carrier 10 including one or more wheels 11 attached to one side or rear portion 12 thereof, and one or more brackets 13 attached to the other side or front portion 14 thereof, and a leveling screw 15 attached to each of the brackets 13, for leveling the carrier 10 relative to the supporting ground or surfaces.

The carrier 10 includes two arms 16 extended upwardly from the front and the rear portions 14, 12 thereof, and each having a bar 17 laterally extended therein. Each of the bars 17 includes a hole 18 formed therein for attaching or securing a resilient pad 19 thereto with such as fasteners 171. It is preferable that the resilient pads 19 are directed or faced toward each other.

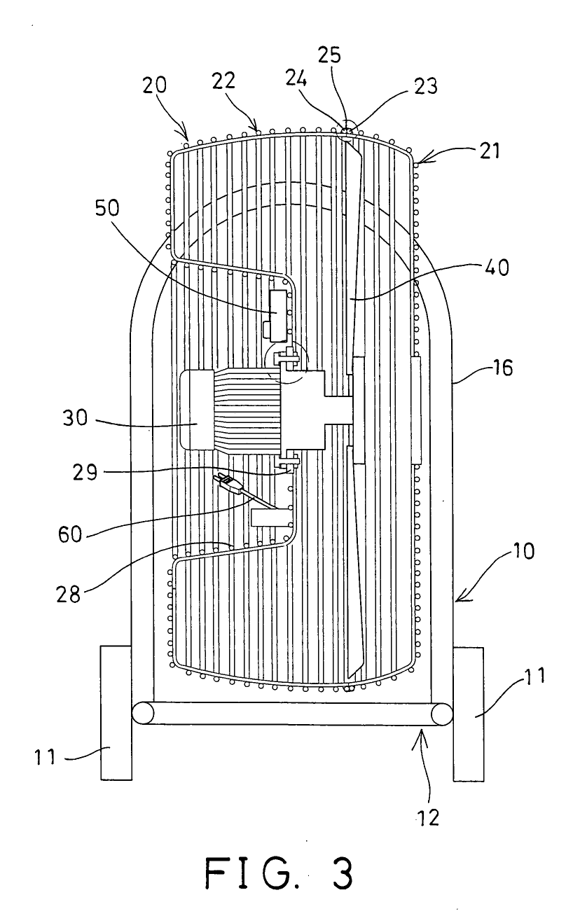

The fan device further includes a net housing 20 having a front cover 21 and a rear casing 22 to be secured together. For example, the cover 21 and the casing 22 include inner peripheral portions 23, 24 engaged or contacted with each other, and secured or coupled together with a ring-shaped or peripheral frame 25 which includes a peripheral recess 27 formed therein and defined between two flaps 26, for receiving and securing the inner peripheral portions 23, 24 of the cover 21 and the casing 22 together, best shown in FIGS. 3, 4.

The net housing 20 is secured between the arms 16 of the carrier 10 with such as bolts or fasteners 171, and engaged with the resilient pads 19 which may protect or cushion the net housing 20, to resiliently support the net housing 20 in the carrier 10. The net housing 20 includes a depression or a concaved chamber 28 formed in the rear portion of the casing 22, for receiving a motor 30. It is preferable that the depth of the concaved chamber 28 is about two thirds (⅔) of the depth of the casing 22.

The motor 30 includes one or more ears 31 extended therefrom and secured to the hub 29 of the casing 22 of the housing 20, with such as fasteners 32 (FIGS. 1, 3, 5), and includes a spindle 33 extended into the housing 20 for attaching or securing a fan member 40 thereto, and for rotating or driving the fan member 40. The motor 30 may thus be received within the concaved chamber 28 of the casing 22 of the housing 20, and protected by the casing 22 and the housing 20. The cover 21 and the casing 22 are arranged to suitably receive the fan member 40 therein, to protect the fan member 40.

A control or switch device 50 may also be received and protected within the concaved chamber 28 of the casing 22 of the housing 20, and secured to the casing 22 of the housing 20, for operating or controlling the fan member 40. The switch device 50 may be coupled to various electric power suppliers with cables 60 which may also be received and protected within the concaved chamber 28 of the casing 22 of the housing 20 (FIGS. 1, 3).

The fan member 40 and the net housing 20 may be stably secured and retained between the arms 16 of the carrier 10, and may be cushioned by or with the pads 19, which may reduce the noises that may be generated by the typical fan devices. In addition, the motor 30 and/or the switch device 50 and/or the cables 60 may be received and protected within the concaved chamber 28 of the casing 22 of the housing 20 and may be prevented from being damaged by other or outer objects inadvertently.

In addition, when one of the arms 16 of the carrier 10 is lifted to space the brackets 13 or the leveling screws 15 from the supporting ground or surfaces, the fan device may be easily moved or transported to various positions with the wheels 11. The fan device may also be stably supported on the supporting ground or surfaces when the leveling screws 15 are engaged with the supporting ground or surfaces.

Accordingly, the fan device includes a stable support to allow the fan device to be stably positioned in place, and to be easily moved or transported to the other places or positions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A fan device comprising:
a net housing including a front cover and a rear casing secured together, said casing including a concaved chamber formed therein,
a motor received in said concaved chamber of said casing, and including a spindle extended into said net housing, and
a fan member attached to said spindle, and to be driven by said motor,
said motor being received within said concaved chamber of said casing of said housing, and protected by said casing of said housing.

2. The fan device as claimed in claim 1, wherein said casing of said housing includes a hub provided therein, said motor includes at least one ear extended therefrom and secured to said hub of said housing.

3. The fan device as claimed in claim 1 further comprising a switch device received in said concaved chamber of said casing, and secured to said casing.

4. The fan device as claimed in claim 1, wherein said cover and said casing include inner peripheral portions contacted with each other, and said housing includes a peripheral frame engaged onto said inner peripheral portions of said cover and said casing, to secure said cover and said casing together.

5. The fan device as claimed in claim 4, wherein said peripheral frame includes a peripheral recess formed therein and defined between two flaps, to receive and secure said inner peripheral portions of said cover and said casing together.

6. The fan device as claimed in claim 1 further comprising a carrier to support said net housing.

7. The fan device as claimed in claim 6, wherein said carrier includes a front portion and a rear portion each having an arm extended therefrom, to secure said net housing between said arms of said carrier.

8. The fan device as claimed in claim 7, wherein each of said arms includes a pad attached thereto and engaged with said net housing, to protect said housing.

9. The fan device as claimed in claim 8, wherein each of said arms includes a bar attached thereto to support said pad.

10. The fan device as claimed in claim 6, wherein said carrier includes at least one wheel attached thereto to allow said carrier to be easily moved.

11. The fan device as claimed in claim 6, wherein said carrier includes at least one leveling screw attached thereto to level said carrier.

12. The fan device as claimed in claim 11, wherein said carrier includes a bracket attached thereto to support said at least one leveling screw.
